(19) United States
(12) Patent Application Publication
(10) Pub. No.: US 2005/0019666 A1
(43) Pub. Date: Jan. 27, 2005

(54) Solid electrolyte, lithium-ion battery and method for producing lithium-ion battery

(76) Inventor: Toshikazu Yasuda, Tokyo (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(21) Appl. No.: 10/891,675

(22) Filed: Jul. 15, 2004

(30) Foreign Application Priority Data
Jul. 23, 2003 (JP) P2003-278497

(51) Int. Cl. H01M 10/40

(52) U.S. Cl. 429/309; 429/317; 29/623.5

(57) ABSTRACT

A lithium-ion battery includes a cathode and an anode capable of being doped with and dedoped from lithium and a solid electrolyte provided between the cathode and the anode. The solid electrolyte comprises a multi-layer structure having three layers or more. A layer nearest to the cathode side and a layer nearest to the anode side of the layers include first polymers which have a low glass transition point, do not have functional groups capable of being crosslinked and are not crosslinked. At least one layer except the layers located at positions nearest to the cathode side and the anode side of the layers includes a second polymer that has a functional group capable of being crosslinked and is crosslinked. Thus, the electrode utilization factor of the cathode and the anode is improved.

### BACKGROUND OF THE INVENTION

1. Field of the Invention

The present invention relates to a solid electrolyte, excellent in its battery characteristics, a lithium-ion battery and a method for producing a lithium-ion battery.

This application claims priority of Japanese Patent Application No. 2003-278497, filed on Jul. 23, 2003, the entirety of which is incorporated by reference herein.

2. Description of the Related Art

In recent years, many portable electronic devices such as a video camera with video tape recorder, a portable telephone, a portable computer, etc. have appeared and an attempt to miniaturize the electronic devices and decrease the weight of them has been made. With the progress of the miniaturization and the decrease of the weight of the electronic devices, batteries used as portable power sources of them have been also requested to become compact and decrease their weight. As the batteries satisfying these requests, for instance, lithium-ion secondary batteries or the like are exemplified.

The lithium-ion secondary battery includes a cathode and an anode capable of being doped with and dedoped from ions and an electrolyte for ion conduction between the cathode and the anode. The electrolyte used in the battery includes, for instance, electrolyte solution obtained by dissolving electrolyte salt in an organic solvent and a solid electrolyte composed of solid having ion conductivity.

When the electrolyte solution is used in the lithium-ion secondary battery, since the organic solvent in the electrolyte solution may possibly leak, sealing characteristics need to be ensured by using a metallic vessel. Therefore, ordinarily, when the electrolyte solution is employed, there are various inconveniences that the weight is large, a troublesome sealing process is required and the degree of freedom in form is low.

On the other hand, when the solid electrolyte is employed, since the organic solvent is not included in the solid electrolyte, there is no fear of the leakage of liquid, and the sealing process for preventing the leakage of liquid can be simplified. The metallic vessel does not need to be used so that the weight can be reduced. The solid electrolyte comprises polymer and electrolyte salt capable of dissociating ions. When a solid polymer electrolyte including, for instance, a polymer compound is used as the solid electrolyte, since the polymer has excellent film forming characteristics, a solid electrolyte battery excellent in its degree of freedom in form selectivity can be advantageously formed.

However, for instance, when lithium composite oxide is used for the cathode and lithium or lithium alloy is used for the anode, an interfacial bonding between the anode and the solid electrolyte is easily obtained so that the anode comes into tightly contact with the solid electrolyte. However, since the cathode is a compound body including lithium composite oxide particles of a cathode active material, a conductive agent and a binding agent, the interfacial bonding between the cathode active material and the solid electrolyte is hardly obtained to deteriorate an adhesion. Accordingly, an interfacial resistance is increased. Thus, in the lithium-ion secondary battery, since the electrode utilization factor of the cathode is lowered, a battery capacity is decreased and battery characteristics such as load characteristics or charging and discharging cycles are deteriorated.

Thus, in order to solve the above-described problems, there is a lithium-ion secondary battery composed of a two-layer structure having a solid electrolyte layer with a soft solid electrolyte and an adhesive property and a hard solid electrolyte layer in which a short-circuit can be prevented. In the above-described lithium-ion secondary battery, the soft solid electrolyte layer having the adhesive property is formed in a cathode side composed of lithium composite oxide or the like to improve an adhesion between the cathode and the solid electrolyte and reduce the interfacial resistance between the cathode and the solid electrolyte. Further, in this lithium-ion secondary battery, the hard solid electrolyte layer capable of preventing the short-circuit is formed in an anode side using alkali metal or the like. Accordingly, the short-circuit between the electrodes due to external pressure can be prevented. Thus, in the lithium-ion secondary battery, an adhesive state between the cathode and the solid electrolyte is improved (see, for instance, Japanese Patent Application Laid-Open No. hei 12-285929).

However, in the lithium-ion secondary battery including such a solid electrolyte, when a carbon material capable of improving charging and discharging cyclic characteristics is used for an anode material, the carbon material is low in its adhesion to the hard solid electrolyte capable of preventing the short-circuit like the cathode active material. Thus, an interfacial resistance between the solid electrolyte and the anode is increased. In the lithium-ion secondary battery using the carbon material, the electrode utilization factor of the anode is decreased and the charging and discharging cyclic characteristics are deteriorated. Further, in the solid electrolyte battery having the solid electrolyte with the above-described two-layer structure, in order to improve the adhesion between the solid electrolyte and the cathode and the anode, when the soft solid electrolyte layer having the adhesive property is also formed in the anode side. Accordingly, when both the two layers are formed with only the soft solid electrolyte layers having the adhesive property, electrodes may possibly pierce the solid electrolyte due to the external pressure to cause the short-circuit.

### SUMMARY OF THE INVENTION

Accordingly, the present invention is proposed by considering the above-described circumstances and it is an object of the present invention to provide a solid electrolyte having a good adhesion to a cathode and an anode and high ionic conductivity, a lithium-ion battery and a method for producing a lithium-ion battery.

A solid electrolyte according to the present invention that achieves the above-described object is provided between a cathode and an anode. The solid electrolyte comprises a multi-layer structure having three layers or more. The layer located at a position nearest to the cathode side and the layer located at a position nearest to the anode side of the layers include first polymers which have a low glass transition point, do not have functional groups capable of being crosslinked and are not crosslinked. At least one layer except the layers located at the positions nearest to the cathode side and the anode side of the layers includes a second polymer that has a functional group capable of being crosslinked and is crosslinked.

A lithium-ion battery according to the present invention that achieves the above-described object has a cathode and an anode capable of being doped with and dedoped from lithium and a solid electrolyte provided between the cathode and the anode. The solid electrolyte comprises a multi-layer structure having three layers or more. The layer located in a position nearest to the cathode side and the layer located in a position nearest to the anode side of the layers include first polymers which have a low glass transition point, do not have functional groups capable of being crosslinked and are not crosslinked. At least one layer except the layers located at the positions nearest to the cathode side and the anode side of the layers includes a second polymer that has a functional group capable of being crosslinked and is crosslinked.

In the present invention having the above-described structure, since the layers located in the positions nearest to the cathode side and the anode side include the first polymers which have the low glass transition point, do not have the functional groups capable of being crosslinked and are not crosslinked. Thus, the layers are soft and have an adhesive property and a good adhesion to the cathode and the anode. Accordingly, an interfacial resistance between the cathode and the anode and the solid electrolyte is decreased.

Further, in the present invention, at least one layer except the layers located in the positions nearest to the cathode side and the anode side includes the second polymer that has the functional group capable of being crosslinked and is crosslinked. Thus, the layer is harder than the layers located in the positions nearest to the cathode side and the anode side. The electrodes do not pierce the solid electrolyte due to external pressure, so that an internal short-circuit can be prevented. Accordingly, in the present invention, an electrode utilization factor is increased, so that battery characteristics such as charging and discharging cycles are improved.

Further, a solid electrolyte according to the present invention that achieves the above-described object is provided between a cathode and an anode. The solid electrolyte comprises parts including polymers high in their crosslinking density in parallel with the electrode planes of the cathode and the anode. The crosslinking density is inclined to be low toward the cathode and the anode from the parts high in their crosslinking density.

Still further, a lithium-ion battery according to the present invention that achieves the above-described object has a cathode and an anode capable of being doped with and dedoped from lithium and a solid electrolyte provided between the cathode and the anode. The solid electrolyte comprises parts including polymers that have functional groups capable of being crosslinked in parallel with the electrode planes of the cathode and the anode and are crosslinked with a high crosslinking density. The crosslinking density is inclined to be low toward the cathode and the anode from the parts high in their crosslinking density.

In the present invention having the above-described structure, the solid electrolyte comprises the parts including the polymers with the high crosslinking density in parallel with the electrode planes of the cathode and the anode. The crosslinking density is inclined to be low toward the cathode and the anode from the parts high in their crosslinking density. Accordingly, the solid electrolyte has such a hardness as to prevent an internal short-circuit and is soft and sticky in parts nearest to the cathode side and the anode side. Thus, according to the present invention, an internal short-circuit is prevented, an adhesion between the cathode and the anode and the solid electrolyte is improved and an electrode utilization factor is increased. As a result, battery characteristics such as charging and discharging cycles are improved.

Further, for achieving the above-described object, a method for producing a lithium-ion battery according to the present invention including a cathode and an anode capable of being doped with and dedoped from lithium and a solid electrolyte provided between the cathode and the anode. The method comprises the steps of: forming on the cathode and the anode first polymer layers having a low glass transition point and no functional group capable of being crosslinked and including a polymer which is not crosslinked, forming a second polymer layer provided between the cathode and the anode so as to be opposed to the first polymer layers, having a functional group capable of being crosslinked and including a crosslinked polymer and allowing the first polymer layers respectively formed on the cathode and the anode and the second polymer layer to be opposed to each other and come into tightly contact with each other.

In the method for producing the lithium-ion battery having the above-described structure, the first polymer layers having the low glass transition point, having no functional groups capable of being crosslinked and including the polymers that are not crosslinked are formed in the cathode side and the anode side. Thus, the first polymer layers are soft, have an adhesive property and are high in their adhesion to the cathode and the anode. Accordingly, an interfacial resistance between the cathode and the anode and the solid electrolyte can be decreased.

Further, in the method for producing the lithium-ion battery, the second polymer layer having the functional group capable of being crosslinked and including the crosslinked polymer is provided between the cathode and the anode. Thus, the second polymer layer is harder than the first polymer layers and the electrodes do not pierce the solid electrolyte due to external pressure or the like. As a result, an internal short-circuit is prevented. Accordingly, since the electrode utilization factor of the cathode and the anode is increased in the method for producing the lithium-ion battery, the lithium-ion battery good in its battery characteristics such as charging and discharging cycles is obtained.

In the present invention, since the solid electrolyte that comes into contact with the cathode and the anode is soft and has the adhesive property, the adhesion to the cathode and the anode is improved and the interfacial resistance between the cathode and the anode and the solid electrolyte is decreased. Accordingly, the electrode utilization factor of the cathode and the anode is increased to improve the battery characteristics such as charging and discharging cycles.

Further, in the present invention, since the solid electrolyte has the part provided with such a hardness as to prevent at least the electrodes from piercing the solid electrolyte due to the external pressure or the like, the internal short-circuit is prevented and a safety is maintained.

### BRIEF DESCRIPTION OF THE DRAWINGS

FIG. 1 is an opened-up plan view showing the structure of a lithium-ion secondary battery to which the present invention is applied.

FIG. 2 is a sectional view taken along a line A₁ to A₂ shown in FIG. 1.

### DETAILED DESCRIPTION OF THE PREFERRED EMBODIMENTS

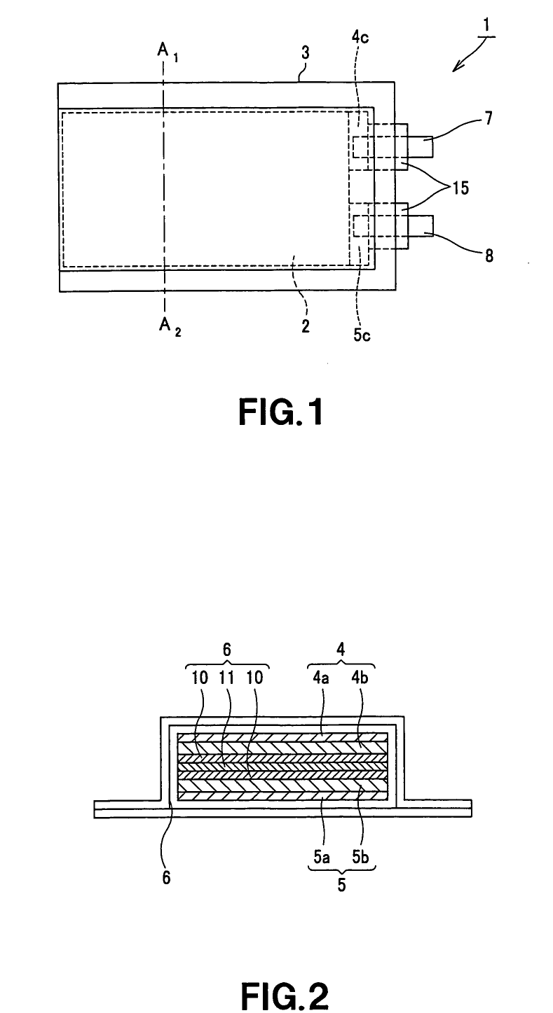

Embodiments of the present invention will be described in detail by referring to the drawings. As a lithium-ion battery to which the present invention is applied, a secondary battery (refer it to as a lithium-ion secondary battery 1, hereinafter) capable of charging and discharging will be described by using FIGS. 1 and 2. The lithium-ion secondary battery 1 includes a battery element 2 doped with and dedoped from lithium ions and an outer package film 3 in which the battery element is accommodated.

The battery element 2 includes a cathode 4 and an anode 5 capable of being doped with and dedoped from the lithium ions and a solid electrolyte 6 provided between the cathode 4 and the anode 5.

The cathode 4 is obtained by forming a cathode active material layer 4b capable of being doped with and dedoped from the lithium ions on a cathode current collector 4a.

As the cathode current collector 4a, metallic foils such as an aluminum foil, a nickel foil, a stainless steel foil, etc. are employed. These metallic foils are preferably porous metallic foils. The metallic foil is made of the porous metallic foil, so that an adhesive strength to the cathode active material layer 4b can be improved. As the porous metallic foil, a metallic foil having many opening parts formed by an etching process may be used as well as punching metal or expanded metal. In the cathode current collector 4a, a cathode lead 7 is ultrasonic-welded to a cathode lead connecting part 4c formed by extending one end. This cathode lead 7 is formed with a metallic foil such as an aluminum foil.

As a cathode active material forming the cathode active material layer 4b, any of materials capable of being doped with and dedoped from light metal ion may be used without especially limiting to specific materials. For instance, metallic oxide, metallic sulfides, or specific polymers may be used. Specifically, as the cathode active material, LiₓMO₂ of lithium containing metallic oxide (in the formula, M represents one or more kinds of transition metals, x is different depending on the charging and discharging state of the battery and ordinarily 0.05 or larger and 1.0 or smaller.) or LiNiₚM1_{q}M2ᵣMO₂ (in the formula, M represents one or more kinds of transition metals. In the formula, M1 and M2 is at least one kind of element selected from a group including Al, Mn, Fe, Co, Ni, Cr, Ti and Zn or non-metallic elements such as P, B, etc. p, q and r satisfy a condition of p+q+r=1. ) may be employed. As the transition metals M forming the lithium composite oxide, Co, Ni, Mn, etc. are preferable. Especially, since lithium cobalt oxides or lithium nickel oxides can obtain high voltage and high energy density and are excellent in their cyclic characteristics, they are preferably used. As specific examples of the lithium cobalt oxides or lithium nickel oxides, LiCoO₂, LiNiO₂, LiNi_{y}Co_{1-y}O₂ (in the formula, y is larger than 0 and smaller than 1.), LiMn₂O₄, etc. may be exemplified. Further, as the cathode active material, metallic oxides or metallic sulfides including no lithium such as TiS₂, MoS₂, NbSe₂, V₂O₅, etc. may be employed. Still further, for the cathode active material layer 4b, a plurality of kinds of cathode active materials of them may be mixed together and the mixture may be used.

As a binding agent used for the cathode 4, for instance, polyvinylidene fluoride (PVdF) or polytetrafluoro ethylene (PTFE) may be used. As a conductive agent used for the cathode 4, for instance, graphite or the like can be used.

The anode 5 is obtained by forming an anode active material layer 5b capable of being doped with or dedoped from lithium ions on an anode current collector 5a.

As the anode current collector 5a, metallic foils such as a copper foil, a nickel foil, a stainless steel foil, etc. are employed. These metallic foils are preferably porous metallic foils. The metallic foil is made of the porous metallic foil, so that an adhesive strength to the anode active material layer 5b can be improved. As the porous metallic foil, a metallic foil having many opening parts formed by an etching process may be used as well as punching metal or expanded metal. In the cathode current collector 5a, an anode lead 8 is ultrasonic-welded to an anode lead connecting part 5c formed by extending one end. This anode lead 8 is formed with a metallic foil such as a nickel foil.

As an anode active material forming the cathode active material layer 5b, any of materials capable of being doped with and dedoped from lithium ions may be used without especially limiting to specific materials. The anode active material layer 5b includes the anode active material and a binding agent and a conductive agent as required. As the anode active material, for instance, materials capable of being doped with and dedoped from alkali metals such as lithium in accordance with charging and discharging reactions may be used. Specifically, conductive polymers such as polyacetylene, polypyrrole and carbon materials such as pyrocarbons, coke, carbon black, vitreous carbons, organic polymer compound sintered bodies, carbon fibers, etc. may be employed. The organic polymer compound sintered bodies indicate materials obtained by sintering the organic polymer materials such as phenolic resins, furan resins, etc. at suitable temperature of 500° C. or higher in inert gas or vacuum. Coke includes petroleum coke, pitch coke, etc. Carbon black includes acetylene black, etc. These carbon materials are extremely effective as the anode active materials from the viewpoint of characteristics that energy density per unit volume is high. Further, as the anode active materials, alkali metals such as lithium, sodium, etc. or alloys including them may be employed.

As the binding agent used for the anode 5, for instance, polyvinylidene fluoride (PVdF), polytetrafluoro ethylene (PTFE), or styrene butadiene copolymer may be employed.

The solid electrolyte 6 has a three-layer structure including first polymer layers 10 respectively provided at positions in contact with the cathode 4 and the anode 5, having a low glass transition point and including first polymers without functional groups capable of being crosslinked and a second polymer layer 11 provided between the first polymer layers 10 respectively provided at positions in contact with the electrodes and including a second polymer having a functional group capable of being crosslinked.

The first polymer layer 10 includes the first polymer having the low glass transition point and including the first polymer without the functional group capable of being crosslinked and electrolyte salt having a solubility to the first polymer. The first polymer has an average molecular weight of, for instance, one hundred thousands or more and a physical property that the glass transition point measured by a differential scanning calorimeter is −60° C. or lower. Specifically, the first polymer is preferably a random copolymer including a component unit whose principal chain structure especially has a structure shown in a below-described chemical formula 1 and a component unit having a structure shown in a below-described chemical formula 2.

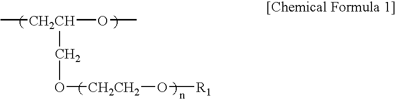

Here, in the above-described formula, R₁ represents a group selected from groups including an alkyl group having the number of carbons of 1 to 12, an alkenyl group having the number of carbons of 2 to 8, a cycloalkyl group having the number of carbons of 3 to 8, an aryl group having the number of carbons of 6 to 14, an aralkyl group having the number of carbons of 7 to 12, and a tetrahydropyranyl group. In the chemical formula, a component unit having a different R₁ may be present in the same polymer chain. Further, n represents an integer of 1 to 12.

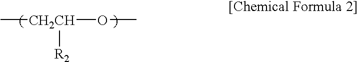

Here, in the above-described formula, R₂ represents an atom or a group selected from groups including hydrogen atom, an alkyl group, an alkenyl group, a cycloalkyl group, an aryl group and an allyl group. In the chemical formula, a component unit having a different R₂ may be present in the same polymer chain. Further, the alkyl group, the alkenyl group, the cycloalkyl group, the aryl group and the allyl group may have substituent groups.

The average molecular weight of the first polymer is set to one hundred thousands so that even when the first polymer layer 10 does not include the functional group capable of being crosslinked, the first polymer layer can be solidified only by twining the polymer chains. Further, the glass transition point of the first polymer is set to −60° C or lower so that the first polymer layer 10 maintains a flexible state and shows a high ionic conductivity throughout a wide temperature range.

As the electrolyte salt, any of electrolyte salts that are dissolved in the polymer included in the first polymer layer 10 and show the ionic conductivity may be used without limiting to specific electrolytes. For instance, lithium hexafluorophosphate (LiPF₆), lithium perchlorate (LiClO₄), lithium hexafluoroarsenate (LiAsF₆), lithium tetrafluoroborate (LiBF₄), lithium trifluoromethane sulfonate (LiCF₃SO₃), lithium bis(trifluoromethyl sulfonyl) imide [LiN(CF₃SO₂)₂], etc. may be employed. In addition to these lithium salts, alkali metal salts such as sodium may be used as the electrolyte salts.

As for the mixing ratio of the electrolyte salt to the random copolymer, assuming that the number of mols of the electrolyte is A and the total number of mols of ethylene oxide unit is B, the value of A/B is preferably 0.0001 or larger and 5 or smaller. The value of A/B is set to 0.0001 or larger, because when the value of A/B is smaller than 0.0001, the conductivity of the solid electrolyte 6 is low and the battery does not function as a battery. The value of A/B is set to 5 or smaller, because when the value of A/B is larger than 5, the ratio of mixing of the electrolyte salt to the polymer is too large, so that the solid electrolyte 6 is hard, the conductivity is low and the battery does not function as a battery.

The first polymer layer 10 formed as described above includes the first polymer in which the average molecular weight is high and the glass transition point measured by the differential scanning calorimeter is low. Thus, the first polymer layer is soft and has an adhesive property. The first polymer layers 10 are provided in contact with the cathode 4 and the anode 5. Thus, the surface of the first polymer layer 10 provided in the cathode 4 side that comes into contact with the cathode 4 is bent along the form of the cathode active material layer 4b due to its soft and adhesive characteristics and the surface of the first polymer layer 10 provided in the anode 5 side that comes into contact with the anode 5 is bent along the form of the anode active material 5b. Thus, the first polymer layers 10 can have a high adhesion to the cathode active material layer 4b and the anode active material layer 5b and can have an interfacial resistance thereto decreased. Accordingly, the electrode utilization factor of the cathode 4 and the anode 5 can be increased. Further, since the first polymer layers 10 have soft characteristics, the first polymer layers 10 can be easily formed along the cathode active material layer 4b of the cathode 4 and the anode active layer 5b of the anode 5 and the battery element 2 can be simply manufactured.

The second polymer layer 11 includes the second polymer that has the functional group capable of being crosslinked and is crosslinked and electrolyte salt having a solubility relative to the second polymer. Specifically, the second polymer has a structure shown by a below-described chemical formula 3. The second polymer is preferably a random copolymer including a polymer shown by the chemical formula 3 and a polymer shown by a chemical formula 4 obtained by copolymerizing the polymer capable of being crosslinked with the polymer having a structure shown by the below-described formula 4.

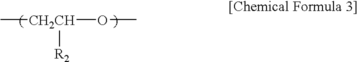

Here, in the above-described formula, R₂ represents an atom or a group selected from groups including hydrogen atom, an alkyl group, an alkenyl group, a cycloalkyl group, an aryl group and an allyl group. In the chemical formula, a component unit having a different R₂ may be present in the same polymer chain. Further, the alkyl group, the alkenyl group, the cycloalkyl group, the aryl group and the allyl group may have substituent groups.

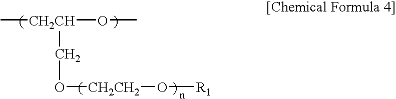

Here, in the above-described formula, R₁ represents a group selected from groups including an alkyl group having the number of carbons of 1 to 12, an alkenyl group having the number of carbons of 2 to 8, a cycloalkyl group having the number of carbons of 3 to 8, an aryl group having the number of carbons of 6 to 14, an aralkyl group having the number of carbons of 7 to 12, and a tetrahydropyranyl group. Further, n represents an integer of 1 to 12.

As the electrolyte salt of the second polymer layer 11, the electrolyte salt soluble in the random copolymer is preferably used. The same electrolyte salts as those used in the first polymer layers 10 are employed.

Since the second polymer layer 11 having the above-described structure is harder than the first polymer layers 10 and the cathode 4 and the anode 5 do not pierce the solid electrolyte 6 due to an external pressure, an internal short-circuit can be prevented. Further, the second polymer layer 11 can be formed in the shape of a film due to its hard property and can be formed with uniform thickness. Further, since the second polymer layer 11 has the hard property, the stability of the battery element 2 can be realized.

Accordingly, in the solid electrolyte 6, the first polymer layers 10 having the soft and adhesive property are located at positions in contact with the cathode 4 and the anode 5. The second polymer layer 11 having the hard property is provided between the first polymer layers 10. Thus, the adhesive property to the cathode 4 and the anode 5 is improved and the internal short-circuit due to the external pressure or the like can be prevented. Further, in the solid electrolyte 6, the second polymer layer 11 is sandwiched in between the first polymer layers 10. Thus, the adhesion between the second polymer layer 11 and the first polymer layers 10 is improved and the interfacial resistance between the second polymer layer 11 and the first polymer layers 10 can be decreased.

In the lithium-ion secondary battery 1 constructed as described above, the solid electrolyte 6 provided between the cathode 4 and the anode 5 includes the first polymer layers 10 having the soft and adhesive property and the second polymer layer 11 having the hard property. The first polymer layers 10 are respectively arranged at the positions coming into contact with the cathode 4 and the anode 5. Thus, the adhesion between the cathode active material layer 4b and the anode active material layer 5b and the solid electrolyte 6 is increased and the interfacial resistance between the cathode active material layer 4b and the anode active material layer 5b and the solid electrolyte 6 is decreased. Further, in the lithium-ion secondary battery 1, the second polymer layer 11 is provided between the first polymer layers 10 provided at the positions coming into contact with the cathode and the anode, so that the electrodes are prevented from piercing the solid electrolyte 6 to cause the internal short-circuit and a safety is maintained. Thus, in the lithium-ion secondary battery 1, load characteristics are lowered and battery characteristics such as charging and discharging cycles are improved. In the lithium-ion secondary battery 1, since a porous film or a non-woven fabric is not used for the solid electrolyte 6, the conductivity of lithium ions is not deteriorated.

The above-described lithium-ion secondary battery 1 is produced in such a manner as described below. Initially, the cathode active material layer 4b is formed on one surface of the cathode current collector 4a to form the cathode 4. Specifically, the cathode 4 is formed in such a way that a cathode composite mixture obtained by mixing the cathode active material with the binding agent is uniformly applied to one surface except the cathode lead connecting part 4c of the metallic foil such as the aluminum foil serving as the cathode current collector 4a and dried to form the cathode active material layer 4b on the cathode current collector 4a. As the binding agent of the cathode composite mixture, not only a well-known binding agent may be used, but also a well-known addition agent may be added to the cathode composite mixture. Further, the cathode active material layer 4b may be formed by using a method such as cast coating, sintering, etc.

Then, the anode active material layer 5b is formed on one surface of the anode current collector 5a to form the anode 5. Specifically, the anode 5 is formed in such a way that an anode composite mixture obtained by mixing the anode active material with the binding agent is uniformly applied to one surface except the anode lead connecting part 5c of the metallic foil such as the copper foil serving as the anode current collector 5a and dried to form the anode active material layer 5b on the anode current collector 5a. As the binding agent of the anode composite mixture, not only a well-known binding agent may be used, but also a well-known addition agent may be added to the anode composite mixture. Further, the anode active material layer 5b may be formed by using a method such as cast coating, sintering, etc.

Then, the first polymer layers 10 of the solid electrolyte 6 are respectively formed on the cathode active material layer 4b of the cathode 4 and the anode active material layer 5b of the anode 5. Specifically, when the first polymer layers 10 are formed, firstly, the random copolymer and the electrolyte salt forming the first polymer layers 10 are dissolved in a solvent to prepare electrolyte solution. Then, the prepared electrolyte solution is uniformly applied to the cathode active material layer 4b and the anode active material layer 5b by a casting method or the like. Subsequently, the cathode active material layer 4b and the anode active material layer 5b are impregnated with the electrolyte solution, and then, the solvent is removed to form the first polymer layers 10 respectively on the cathode active material layer 4b and the anode active material layer 5b.

Then, the second polymer layer 11 provided between the first polymer layers 10 is formed. Specifically, when the second polymer layer 11 is formed, the random copolymer and the electrolyte salt forming the second polymer layer 11 are dissolved in a solvent to prepare electrolyte solution. Then, the electrolyte solution is uniformly applied to, for instance, a Teflon (a registered trademark) plate or the like by the casting method, and then, the solvent is removed. Then, the plate with electrolyte solution applied is irradiated with ultraviolet rays to generate a radical polymerization and solidification and form the second polymer layer 11.

Then, the cathode lead 7 is ultrasonic-welded to the cathode lead connecting part 4c formed by extending one end of the cathode current collector 4a of the battery element 2. The anode lead 8 is ultrasonic-welded to the anode lead connecting part 5c formed by extending one end of the anode current collector 5a.

After that, the cathode 4 and the anode 5 having the first polymer layers 10 formed as described above and the second polymer layer 11 are laminated so that the first polymer layers 10 respectively formed on the cathode active material layer 4b and the anode active material layer 5b are opposed to the second polymer layer 11 and the second polymer layer 11 is interposed between the first polymer layers 10 to form the solid electrolyte 6. Thus, the battery element 2 is manufactured that has the solid electrolyte 6 having the three-layer structure formed between the cathode 4 and the anode 5.

Then, the battery element 2 is enveloped by the outer package film 3 folded in two so as to draw out the cathode lead 7 and the anode lead 8 of the battery element 2. The outer package film 3 is sealed under reduced pressure to form the lithium-ion secondary battery 1. In the parts of the cathode lead 7 and the anode lead 8 coming into contact with the outer package film 3, a sealant 15 is provided to improve an adhesion between the cathode lead 7 and the anode lead 8 and the outer package film 3.

In the lithium-ion secondary battery 1 manufactured by the above-described method, the first polymer layers 10 having the soft and adhesive property are formed on the cathode active material layer 4b of the cathode 4 and the anode active material layer 5b of the anode 5. Thus, the random copolymer and the electrolyte salt infiltrate into the cathode active material layer 4b and the anode active material layer 5b to increase the adhesion to the cathode active material layer 4b and the anode active material layer 5b and decrease the interfacial resistance.

Further, in the method for producing the lithium-ion secondary battery 1, the second polymer layer 11 is provided between the first polymer layers 10 formed on the cathode active material layer 4b of the cathode 4 and the anode active material layer 5b of the anode 5 to form the battery element 2. Thus, since the second polymer layer 11 has the hard property, the cathode 4 and the anode 5 are prevented from piercing the solid electrolyte 6 to cause short-circuit between the electrodes. Accordingly, in the method for producing the lithium-ion secondary battery 1, the electrode utilization factor of the cathode 4 and the anode 5 is increased. Consequently, the lithium-ion secondary battery 1 in which the battery characteristics such as charging and discharging cycles are good and a safety is maintained can be obtained.

When the lithium-ion secondary battery 1 according to the above-described embodiment is applied to various kinds of forms such as a cylindrical form or a prismatic form, the same effects can be obtained. Further, the lithium-ion battery may be also applied to a primary battery.

Now, preferred examples of the present invention will be described on the basis of experimental results. The conditions of the solid electrolyte layer are changed to form three kinds of lithium-ion secondary batteries for measurement including Example 1 and Comparative Examples 1 to 2 and evaluate battery characteristics.

### EXAMPLE 1

A cathode was formed as described below. Firstly, lithium composite oxide of LiCoO₂ of 91 parts by weight as a cathode active material, graphite of 6 parts by weight as a conductive agent and polyvinylidene fluoride of 3 parts by weight as a binding agent were mixed together to have a cathode composite mixture. The cathode composite mixture was dissolved in 1-methyl-2-pyrrolidone as a solvent to obtain slurry type cathode application solution.

Then, the obtained cathode application solution was applied to a rectangular aluminum foil as a cathode current collector so as to have the application density of 1.41 mg/cm². The cathode application solution was dried at 110° C., and compression-molded by a roll press machine to form the cathode having a cathode active material layer laminated on the cathode current collector. Then, the aluminum foil was cut into a rectangular form to manufacture a cathode lead. The cathode lead was attached to the cathode current collector under pressure.

Then, an anode was formed. Firstly, graphite having an average particle diameter of 3 μm of 90 parts by weight as an anode active material and polyvinylidene fluoride (PVdF) of 10 parts by weight as a binding agent were mixed together to have an anode composite mixture. The anode composite mixture was dissolved in 1-methyl-2-pyrrolidone as a solvent to obtain slurry type anode application solution.

Then, the obtained anode application solution was applied to a rectangular copper foil as an anode current collector so as to have the application density of 0.6 mg/cm². The anode application solution was dried at 110° C., and compression-molded by a roll press machine to form the anode having an anode active material layer laminated on the anode current collector. Then, the nickel foil was cut into a rectangular form to manufacture an anode lead. The anode cathode lead was attached to the anode current collector under pressure.

Then, first polymer layers forming a solid electrolyte were formed on the cathode and the anode in such a way as described below. Firstly, a solid type random copolymer whose principal structure included a component unit of 25 mol % having a structure shown by a below-described chemical formula 5 and a component unit of 75 mol % having a structure shown by a below-described chemical formula 6, whose average molecular weight was one thousand thousands and whose glass transition point measured by a differential scanning calorimeter was −60° C. was prepared. Lithium tetrafluoroborate (LiBF₄) was weighed so that it is assumed that the number of mols of electrolyte salt is A and the total number of mols of ethylene oxide unit is B, as the mixing ratio of the electrolyte salt to the random copolymer, the value A/B was 0.06. Solution obtained by dissolving the random copolymer and the weighed lithium tetrafluoroborate (LiBF₄) into acetonitrile as a solvent was uniformly applied on the cathode active material layer by a casting method or the like. After that, the solution was dried in vacuum to remove acetonitrile as the solvent to form the first polymer layer having the thickness of 10 μm on the cathode. In the same manner, the first polymer layer was formed on the anode.

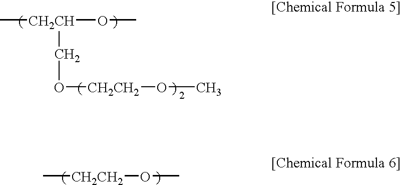

Then, a second polymer layer disposed between the first polymer layers was formed in such a way as described below. Firstly, a solid type random copolymer whose principal structure included the component unit of 20.6 mol % having the structure shown by the above-described chemical formula 5, the component unit of 77.5 mol % having the structure shown by the above-described chemical formula 6 and a component unit of 1.9 mol % having a structure shown by a below-described chemical formula 7 and whose average molecular weight was one thousand thousands was prepared. Lithium tetrafluoroborate (LiBF₄) was weighed so that it is assumed that the number of mols of lithium electrolyte salt is A and the total number of mols of ethylene oxide unit is B, as mixing ratio of the lithium electrolyte salt to the random copolymer, the value A/B was 0.06. A photosensitizer was dissolved into solution obtained by dissolving the random copolymer and the weighed lithium tetrafluoroborate (LiBF₄) into acetonitrile as the solvent to prepare the solution. The prepared solution was uniformly applied on a smooth Teflon (registered trademark) plate. After that, the solution was dried in vacuum to remove acetonitrile. The dried solution was irradiated with ultraviolet rays, radically polymerized and solidified to form the second polymer layer having the thickness of 50 μm

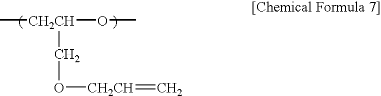

Then, a battery element was formed in such a way as described below. The first polymer layers respectively formed on the cathode and the anode are opposed to the second polymer layer and pressed thereto to form the battery element.

Now, in the battery element, the cathode lead and the anode lead were drawn out and the battery element was sealed under reduced pressure and accommodated in an outer package film. Thus, the lithium-ion secondary battery was formed.

### COMPARATIVE EXAMPLE 1

When the battery element was formed, the first polymer layers were not formed on the cathode and the anode and only the second polymer layer having the thickness of 50 μm was formed between the cathode and the anode. The lithium-ion secondary battery was formed in the same manner as that of the Example 1 except this battery element was used.

### COMPARATIVE EXAMPLE 2

When the battery element was formed, the first polymer layers having the thickness of 35 μm were formed respectively on the cathode and the anode and the first polymer layers were opposed to each other. The lithium-ion secondary battery was formed in the same manner as that of the Example 1 except that this battery was used.

A charging and discharging test was carried out to the lithium-ion secondary batteries of the Example 1, the Comparative Example 1 and the Comparative Example 2 formed as described above.

Specifically, a constant-current and constant-voltage charging operation was carried out with the charging current value of 0.1 C and the constant voltage of 4.2 V as an upper limit in an atmosphere of 50° C. until the charging current value was restricted to 0.005 C. Then, a low current discharging operation was carried out with the discharging current value of 0.1 C up to the end voltage of 3.0 V. Then, an initial discharging capacity was measured. The measured results of the initial discharging capacity of the Example 1, the Comparative Example 1 and the Comparative Example 2 are shown in Table 1.

TABLE 1

| | Initial Discharging Capacity |
|---|---|
| | (mAh/g) |
| Example 1 | 0.2 |
| Comparative | 0.07 |
| Example 1 | |
| Comparative | Short-circuit |
| Example 2 | |

In accordance with the measured results shown in the Table 1, the lithium-ion secondary battery of the Example 1 having the three-layer structure including the first polymer layers with the solid electrolyte provided on the cathode and the anode and the second polymer layer provided between the first polymer layers had the initial discharging capacity of 0.2 mAh/g. Thus, the lithium-ion secondary battery of the Example 1 could obtain the initial discharging capacity higher than those of the lithium-ion secondary batteries of the Comparative Example 1 and the Comparative Example 2 in which the solid electrolyte layer is composed only of the first polymer layers or the second polymer layer.

In the Comparative Example 1, since the solid electrolyte layer was composed only of the second polymer layer, an adhesion between the solid electrolyte and the cathode and the anode was low, an interfacial resistance between the solid electrolyte and the cathode and the anode was increased and the initial discharging capacity was 0.07 mAh/g.

In the Comparative Example 2, since the solid electrolyte was composed only of the first polymer layers, the electrodes pierced the first polymer layers having a soft property while the battery element was formed or the charging and discharging operations were evaluated. Thus, the cathode came into contact with the anode to cause short-circuit.

As compared with the above-described Comparative Examples, in the Example 1, the solid electrolyte included the first polymer layers having a soft and adhesive property and the second polymer layer having a hard property and the first polymer layers were provided at positions coming into contact with the cathode and the anode. Thus, the adhesion to the cathode and the anode was improved, the interfacial resistance was lowered and the battery characteristics were improved. Further, in the Example 1, since the second polymer layer having the hard property was provided between the first polymer layers, even when the electrodes pierced the first polymer layers, the short-circuit between the electrodes was prevented. Accordingly, in the Example 1, the electrode utilization factor of the cathode and the anode was improved and the initial discharging capacity was improved.

As described above, in the lithium-ion secondary battery, the solid electrolyte provided between the cathode and the anode includes the first polymer layers having the soft and adhesive property and the second polymer layer having the hard property. The first polymer layers are arranged at the positions coming into contact with the cathode and the anode and the second polymer layer is provided between the first polymer layers. Thus, the interfacial resistance between the cathode and the anode and the solid electrolyte can be reduced and the electrode utilization factor of the cathode and the anode is improved. Further, in the lithium-ion secondary battery, even when the first polymer layers having the soft and adhesive property are arranged at the positions coming into contact with the cathode and the anode, the second polymer layer having the hard property is provided between the first polymer layers so that the short-circuit between the electrodes is prevented and a safety is maintained. Therefore, in the lithium-ion secondary battery, the load characteristics are lowered and the battery characteristics such as charging and discharging cycles are improved.

While the invention has been described in accordance with certain preferred embodiments thereof illustrated in the accompanying drawings and described in the above description in detail, it should be understood by those ordinarily skilled in the art that the invention is not limited to the embodiments, but various modifications, alternative constructions or equivalents can be implemented without departing from the scope and spirit of the present invention as set forth and defined by the appended claims.

1. A solid electrolyte provided between a cathode and an anode, said solid electrolyte comprising:
a multi-layer structure having three layers or more; wherein a layer nearest to the cathode side and a layer nearest to the anode side of the layers include first polymers which have a low glass transition point, do not have functional groups capable of being crosslinked and are not crosslinked and at least one layer except the layers located at positions nearest to the cathode side and the anode side of the layers includes a second polymer that has a functional group capable of being crosslinked and is crosslinked.

2. The solid electrolyte according to claim 1, wherein the first polymer and the second polymer are random copolymers including a component unit having a structure shown in a below-described chemical formula 1 and a component unit having a structure shown in a below-described chemical formula 2. 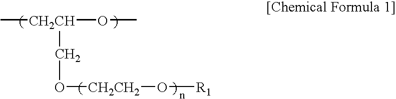
(Here, in the above-described formula, R₁ represents a group selected from groups including an alkyl group having the number of carbons of 1 to 12, an alkenyl group having the number of carbons of 2 to 8, a cycloalkyl group having the number of carbons of 3 to 8, an aryl group having the number of carbons of 6 to 14, an aralkyl group having the number of carbons of 7 to 12 and a tetrahydropyranyl group, and n represents an integer of 1 to 12.) 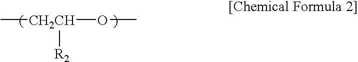
(Here, in the above-described formula, R₂ represents an atom or a group selected from groups including hydrogen atom, an alkyl group, an alkenyl group, a cycloalkyl group, an aryl group, and an allyl group.).

3. A solid electrolyte provided between a cathode and an anode; said solid electrolyte comprising:
parts including polymers high in their crosslinking density in parallel with the electrode planes of the cathode and the anode, wherein the crosslinking density is inclined so as to be lowered toward the cathode and the anode from the part high in its crosslinking density.

4. The solid electrolyte according to claim 3, wherein the polymers have a low glass transition point, are not crosslinked and have the lowest crosslinking density in parts nearest to the cathode side and the anode side.

5. The solid electrolyte according to claim 3, wherein the polymers are random copolymers including a component unit having a structure shown in a blow-described chemical formula 3 and a component unit having a structure shown in a below-described chemical formula 4. 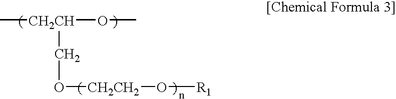
(Here, in the above-described formula, R₁ represents a group selected from groups including an alkyl group having the number of carbons of 1 to 12, an alkenyl group having the number of carbons of 2 to 8, a cycloalkyl group having the number of carbons of 3 to 8, an aryl group having the number of carbons of 6 to 14, an aralkyl group having the number of carbons of 7 to 12 and a tetrahydropyranyl group, and n represents an integer of 1 to 12.) 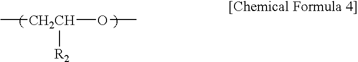
(Here, in the above-described formula, R₂ represents an atom or a group selected from groups including hydrogen atom, an alkyl group, an alkenyl group, a cycloalkyl group, an aryl group, and an allyl group.).

6. A lithium-ion battery having a cathode and an anode capable of being doped with and dedoped from lithium and a solid electrolyte provided between the cathode and the anode, said solid electrolyte comprising:
a multi-layer structure having three layers or more; wherein a layer nearest to the cathode side and a layer nearest to the anode side of the layers include first polymers which have a low glass transition point, do not have functional groups capable of being crosslinked and are not crosslinked and at least one layer except the layers located at positions nearest to the cathode side and the anode side of the layers includes a second polymer that has a functional group capable of being crosslinked and is crosslinked.

7. The lithium-ion battery according to claim 6, wherein in the solid electrolyte, the first polymer and the second polymer are composed of random copolymers including a component unit having a structure shown in a below-described chemical formula 5 and a component unit having a structure shown in a below-described chemical formula 6 and soluble electrolyte salt is included in the random copolymers. 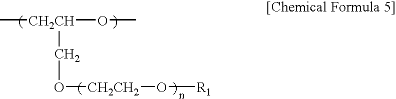
(Here, in the above-described formula, R₁ represents a group selected from groups including an alkyl group having the number of carbons of 1 to 12, an alkenyl group having the number of carbons of 2 to 8, a cycloalkyl group having the number of carbons of 3 to 8, an aryl group having the number of carbons of 6 to 14, an aralkyl group having the number of carbons of 7 to 12 and a tetrahydropyranyl group, and n represents an integer of 1 to 12.) 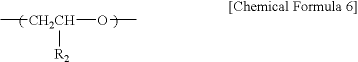
(Here, in the above-described formula, R₂ represents an atom or a group selected from groups including hydrogen atom, an alkyl group, an alkenyl group, a cycloalkyl group, an aryl group, and an allyl group.).

8. The lithium-ion battery according to claim 6, wherein the anode is made of a carbon material.

9. A lithium-ion battery having a cathode and an anode capable of being doped with and dedoped from lithium and a solid electrolyte provided between the cathode and the anode, said solid electrolyte comprising:
parts including polymers that have functional groups capable of being crosslinked in parallel with the electrode planes of the cathode and the anode and are crosslinked with a high crosslinking density, wherein the crosslinking density is inclined so as to be lowered toward the cathode and the anode from the part having the high crosslinking density.

10. The lithium-ion battery according to claim 9, wherein the solid electrolyte includes the polymers that have a low glass transition point at positions nearest to the cathode side and the anode side and are not crosslinked.

11. The lithium-ion battery according to claim 9, wherein in the solid electrolyte, the first polymer and the second polymer are random copolymers including a component unit having a structure shown in a below-described chemical formula 7 and a component unit having a structure shown in a below-described chemical formula 8 and soluble electrolyte salt is included in the random copolymers. 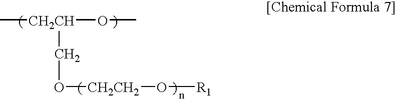
(Here, in the above-described formula, R₁ represents a group selected from groups including an alkyl group having the number of carbons of 1 to 12, an alkenyl group having the number of carbons of 2 to 8, a cycloalkyl group having the number of carbons of 3 to 8, an aryl group having the number of carbons of 6 to 14, an aralkyl group having the number of carbons of 7 to 12 and a tetrahydropyranyl group, and n represents an integer of 1 to 12.) 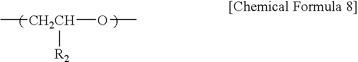
(Here, in the above-described formula, R₂ represents an atom or a group selected from groups including hydrogen atom, an alkyl group, an alkenyl group, a cycloalkyl group, an aryl group, and an allyl group.).

12. The lithium-ion battery according to claim 9, wherein the anode is made of a carbon material.

13. A method for producing a lithium-ion battery including a cathode and an anode capable of being doped with and dedoped from lithium and a solid electrolyte provided between the cathode and the anode, said method comprising the steps of:
forming on the cathode and the anode first polymer layers having a low glass transition point and no functional group capable of being crosslinked and including a polymer which is not crosslinked;
forming a second polymer layer provided between the cathode and the anode so as to be opposed to the first polymer layers, having a functional group capable of being crosslinked and including a crosslinked polymer and allowing the first polymer layers respectively formed on the cathode and the anode and the second polymer layer to be opposed to each other and come into tightly contact with each other.
